(19) United States
(12) Patent Application Publication
(10) Pub. No.: US 2024/0289885 A1
(43) Pub. Date: Aug. 29, 2024

(54) System and Method for Optimizing Tax and Estate Planning and Jurisdiction Selection Using Artificial Intelligence

(71) Applicant: RENATO BACCARO, San Diego, CA (US)

(72) Inventor: RENATO BACCARO, San Diego, CA (US)

(21) Appl. No.: 18/637,513

(22) Filed: Apr. 17, 2024

Related U.S. Application Data
(60) Provisional application No. 63/573,669, filed on Apr. 3, 2024.

(51) Int. Cl. G06Q 40/06; G06Q 30/0203

(52) U.S. Cl. CPC G06Q 40/06; G06Q 30/0203

(57) ABSTRACT

A computer-implemented method and a computer system for strategic financial planning across jurisdictions is disclosed. The computer-implemented method includes user specific data via an interface module based on a series of inputs from a user. A database is accessed containing historical data of tax laws, legal compliance requirements, and business efficiency metrics across a plurality of jurisdictions. The user specific data is analysed based on the historical data across the plurality of jurisdictions using a plurality of machine learning models. A ranked list of jurisdictional recommendations, and entity formation corresponding to the series of inputs is provided based on the analysis.

### BACKGROUND

### Technical Field

The present disclosure relates generally to the field of financial planning and legal technology and more particularly to a method and system for strategic financial planning across jurisdictions using artificial intelligence.

### Description of the Related Art

The complexities of global tax laws, estate planning, and business entity formation present significant challenges for individuals and businesses aiming to optimize their financial and legal standings. Navigating the intricate web of international tax regulations, legal compliance, and business efficiency metrics requires expert knowledge and extensive research. Individuals and organizations must make critical decisions regarding jurisdiction selection and entity formation that can have profound implications on their tax liabilities, legal obligations, and overall business efficiency. The dynamic nature of global laws and policies further complicates this process, necessitating continuous monitoring and adjustment to ensure optimal decision-making.

Traditionally, the process of tax and estate planning, jurisdiction selection, and entity formation has relied heavily on consultation with legal and financial experts. Professionals in these fields utilize their knowledge and experience to advise clients, often employing manual research methods to gather the latest information on tax laws, legal requirements, and business conditions across different jurisdictions. While consulting with experts provides valuable insights, this approach has several limitations. Professional advisory services can be prohibitively expensive and may not be accessible to all individuals or small businesses. This creates a barrier to optimizing financial and legal planning.

The manual process of gathering and analysing data from multiple jurisdictions is time-consuming. It can delay decision-making and may result in missed opportunities. Traditional methods often provide a snapshot analysis that may not account for the dynamic nature of global tax laws and business conditions. They may fail to offer adaptive recommendations in response to changing regulations and market environments. While professionals attempt to tailor their advice, the complexity and scope of global data can limit the ability to fully customize recommendations to the unique circumstances of each client. The sheer volume of relevant data can be overwhelming, and critical insights may be lost in the vast amount of information available.

Therefore, there is a need for a method and system for strategic financial planning across jurisdictions using artificial intelligence to overcome these limitations. An ideal system would automate and streamline the process of gathering, analysing, and applying the vast array of data related to tax laws, legal requirements, and business efficiency metrics across multiple jurisdictions. Such a system would offer personalized, dynamic, and cost-effective recommendations for tax and estate planning, jurisdiction selection, and entity formation, ensuring that individuals and businesses can make informed decisions optimized for their specific situations.

### BRIEF SUMMARY

According to an embodiment of the present disclosure, a computer-implemented method for strategic financial planning across jurisdictions is provided. In the computer-implemented method, user specific data may be received via an interface module based on a series of inputs from a user. The series of inputs corresponds to tax planning needs, financial needs, business needs, and estate planning needs of the user. The user specific data comprises tax planning data, financial data, business data, and estate planning data. Further, a database containing historical data of tax laws, legal compliance requirements, and business efficiency metrics across a plurality of jurisdictions may be accessed. Further, the user specific data may be analysed based on the historical data across the plurality of jurisdictions using a plurality of machine learning models. The plurality of machine learning models may be trained based on the historical data to analyse the user specific data. Further A ranked list of jurisdictional recommendations, and entity formation corresponding to the series of inputs based on the analysis.

According to another embodiment of the present disclosure, a computer system for strategic financial planning across jurisdictions is provided. The computer system includes an interface module configured to collect user specific data based on a series of inputs from a user, the series of inputs corresponds to tax planning needs, financial needs, business needs, and estate planning needs of the user. The user specific data includes tax planning data, financial data, business data, and estate planning data. The computer system further includes a database containing historical data of tax laws, legal compliance requirements, and business efficiency metrics across a plurality of jurisdictions. The computer system further includes a processor configured to analyse the user specific data based on the historical data across the plurality of jurisdictions using a plurality of machine learning models. The plurality of machine learning models may be trained based on the historical data to analyse the user specific data. The processor may be further configured to provide a ranked list of jurisdictional recommendations, entity formation, and its relationship corresponding to the user specific data based on the analysis.

According to another embodiment of the present disclosure, a non-transitory computer-readable storage medium storing computer-executable instructions which when executed by a computer system cause the computer system to receive user specific data based on a series of inputs from a user. The series of inputs may correspond to tax planning needs, financial business needs, and estate planning needs of the user. The user specific data includes tax planning data, financial data, business data, and estate planning data. The computer-executable instructions further cause the computer system to access a database containing historical data of tax laws, legal compliance requirements, and business efficiency metrics across a plurality of jurisdictions. The computer-executable instructions further cause the computer system to analyse the user specific data based on the historical data across the plurality of jurisdictions using a plurality of machine learning models. The plurality of machine learning models is trained based on the historical data to analyse the user specific data. The computer-executable instructions further cause the computer system to provide a ranked list of jurisdictional recommendations, and entity formation corresponding to the series of inputs based on the analysis.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 depicts a block diagram of a network of data processing systems in accordance with an illustrative embodiment.

FIG. 2 depicts a block diagram of a computing environment in accordance with an illustrative embodiment.

FIG. 3 depicts a strategic planning system in accordance with an illustrative embodiment.

FIG. 4 depicts a routine for strategic financial planning across jurisdictions in accordance with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to a method and system for strategic financial planning across jurisdictions using artificial intelligence.

The system facilitates strategic financial planning tailored to the specific needs of users across multiple jurisdictions including tax planning, financial needs, business requirements, and estate planning.

Through the interface module, the system efficiently collects user-specific data through a dynamic questionnaire, ensuring that the information gathered is relevant and comprehensive.

The system utilizes machine learning models, including neural networks and decision trees, trained on historical data to analyze user-specific data and provide optimized jurisdictional recommendations and entity formation strategies.

The system maintains a database of historical data on tax laws, legal compliance requirements, and business efficiency metrics across multiple jurisdictions, regularly updated to reflect changes and ensure accuracy.

The system incorporates a feedback module that enables users to provide feedback on the recommendations, allowing for refinement and improvement of the machine learning models over time.

An objective of the present disclosure is to streamline the process of strategic financial planning across jurisdictions, making it more efficient and accessible to users.

Another objective of the present disclosure is to provide accurate and reliable jurisdictional recommendations and entity formation strategies.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures, therefore, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Example Data Processing Environment

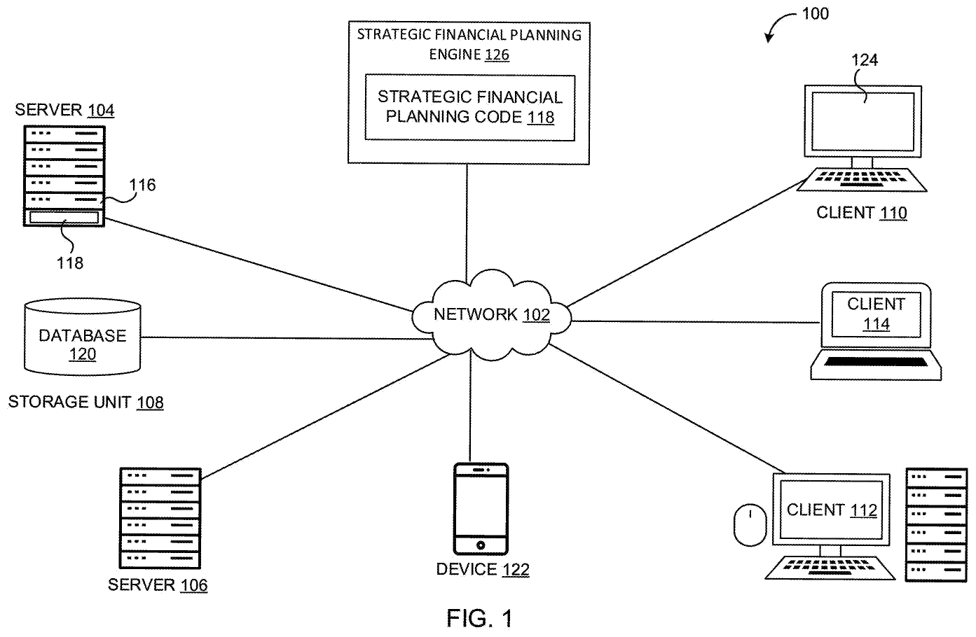

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), strategic financial planning engine 126, and device 122 may include data and may have software applications or software tools executing thereon. Server 104 and server 106 may include one or more GPUs (graphics processing units) for statistical analysis or machine learning.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system, which are all within the scope of the illustrative embodiments.

Data processing systems such as strategic financial planning engine 126, server 104, server 106, client 110, client 112, client 114, device 122) also represent example nodes in a cluster, partitions, and other configurations suitable for implementing an embodiment.

Server 104, server 106, storage unit 108, client 110, client 112, client 114, device 122, strategic financial planning engine 126 may couple to network 102 using wired connections, wireless communication protocols, or other suitable data connectivity. Client 110, client 112 and client 114 may be, for example, personal computers or network computers.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Server application 116, client application 124 and/or strategic financial planning engine 126 may include strategic financial planning Code 118 configured for financial plannings. In some embodiments, strategic financial planning engine 126 may be or form a part of a server or client described herein.

Device 122 is an example of a device described herein. For example, device 122 can take the form of a smartphone, a tablet computer, a laptop computer, client 110 in a stationary or a portable form, or any other suitable device. Any software application described as executing in another data processing system in FIG. 1 can be configured to execute in device 122 in a similar manner. Any data or information stored or produced in another data processing system in FIG. 1 can be configured to be stored or produced in device 122 in a similar manner. Database 120 of storage unit 108 may store historical data for computations herein. The historical data may include data on tax rates, legal compliance requirements, business metrics, and any other relevant jurisdictional information.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 200 includes an example of an environment for the execution of at least some of the computer code involved in performing the inventive methods, such as strategic financial planning code 118. The strategic financial planning code 118 may receive user specific data based on a series of inputs from a user. The strategic financial planning code 118 may further access the database 120 containing historical data of tax laws, legal compliance requirements, and business efficiency metrics across a plurality of jurisdictions. The strategic financial planning code 118 may further analyse the user specific data based on the historical data across the plurality of jurisdictions using a plurality of machine learning models. The strategic financial planning code 118 may further provide a ranked list of jurisdictional recommendations, and entity formation corresponding to the series of inputs based on the analysis.

In addition to the strategic financial planning code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and the strategic financial planning code 118, as identified above), peripheral device set 218 (including user interface (UI) devices set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

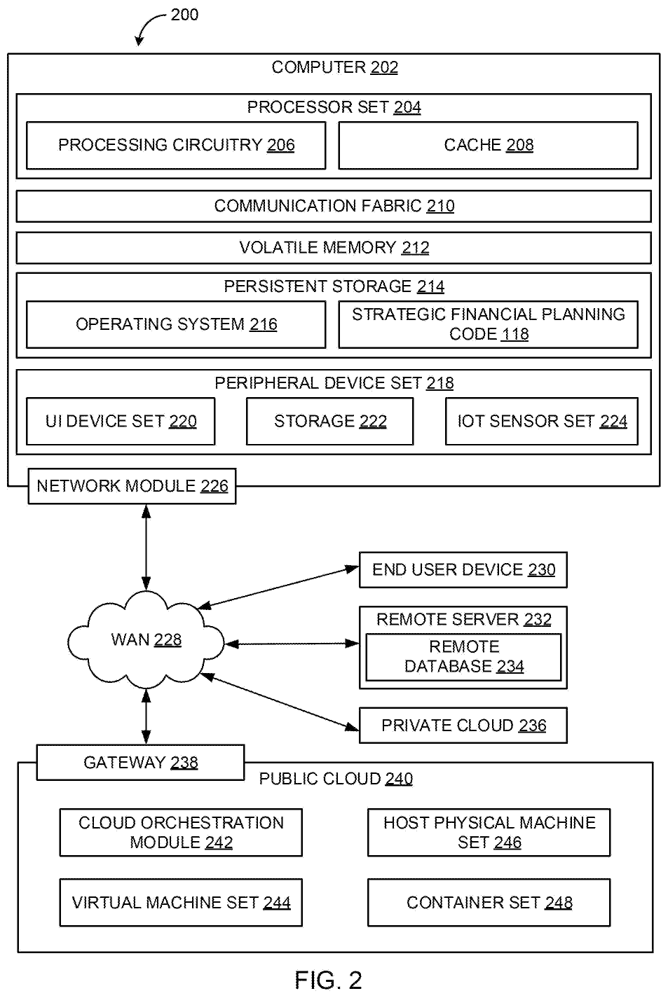

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in the strategic financial planning code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214 may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in the strategic financial planning code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

### Example Architecture

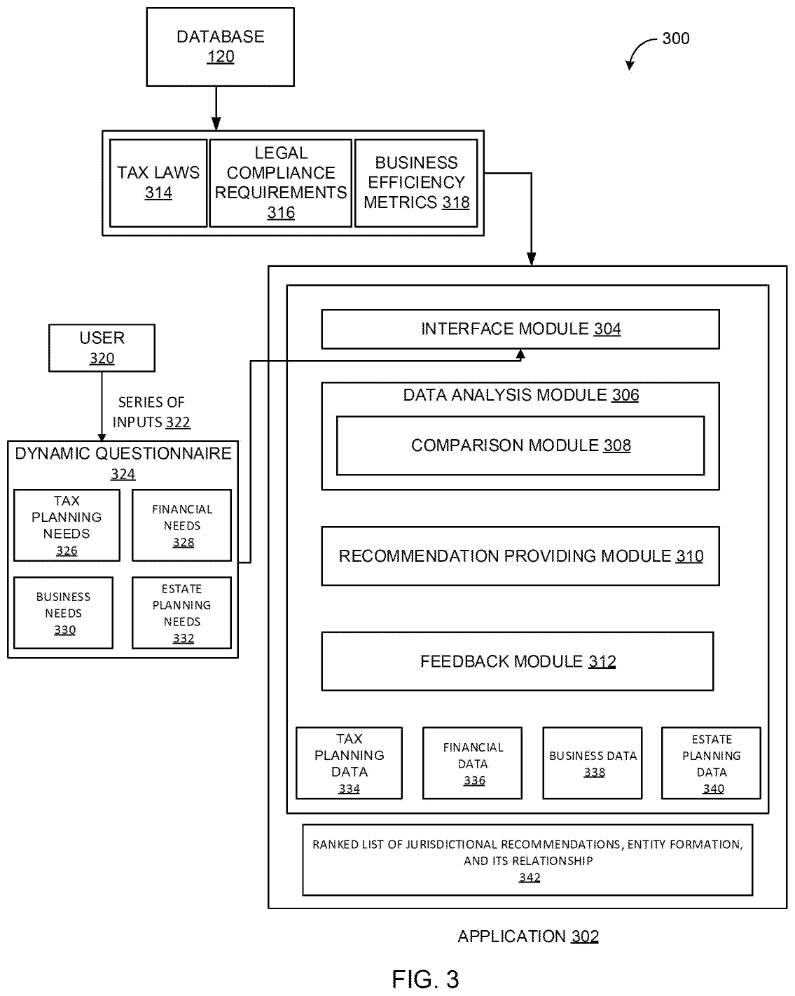

Reference now is made to FIG. 3, a strategic planning system 300 in accordance with an illustrative embodiment. FIG. 3 is explained in conjunction with FIGS. 1 and 2. The strategic planning system 300 comprises the database 120, an application 302 which may include or operate an interface module 304, a data analysis module 306, a recommendation providing 308, and a feedback module. The database 120 may include historical data of tax laws 314, legal compliance requirements 316, and business efficiency metrics 318 across a plurality of jurisdictions.

The interface module 304 may serve as the primary user interaction gateway. The interface module 304 may be designed to collect user specific data from a user 320 through a dynamic questionnaire 324. The dynamic questionnaire 324 may adapt based on user responses to ensure a comprehensive understanding of the user's financial situation, business structure, estate planning needs, and any specific preferences or constraints. The dynamic questionnaire 324 may collect the user specific data through the series of inputs 322. The series of inputs corresponds to tax planning needs 326, financial needs 328, business needs 330, and estate planning needs 332 of the user 320. The user specific data may include tax planning data 334, financial data 336, business data 338, and estate planning data 340.

The data analysis module 306 may include a comparison module 308. The data analysis module 306 may access the database 120 to analyse the user specific data based on the historical data across the plurality of jurisdictions using a plurality of machine learning models. The plurality of machine learning models may be trained based on the historical data to analyse the user specific data. The user specific data may be analysed by the comparison module 306 based on comparison of the tax laws 314, the legal compliance requirements 316, and the business efficiency metrics 318 corresponding to the user specific data across the plurality of jurisdictions. The plurality of machine learning models may include neural networks, decision trees, specifically optimized for analysing the user specific data.

Further, the recommendation providing module 310 may provide a ranked list of jurisdictional recommendations, entity formation, and its relationship 342 corresponding to the user specific data based on the analysis.

Further, feedback may be received from the user via the feedback module 312 on the ranked list of jurisdictional recommendations entity formation, and its relationship 342. The received feedback may be utilized to refine and improve the plurality of machine learning models. The ranked list of jurisdictional recommendations, entity formation, and its relationship 342 may be updated based on the refined machine learning models.

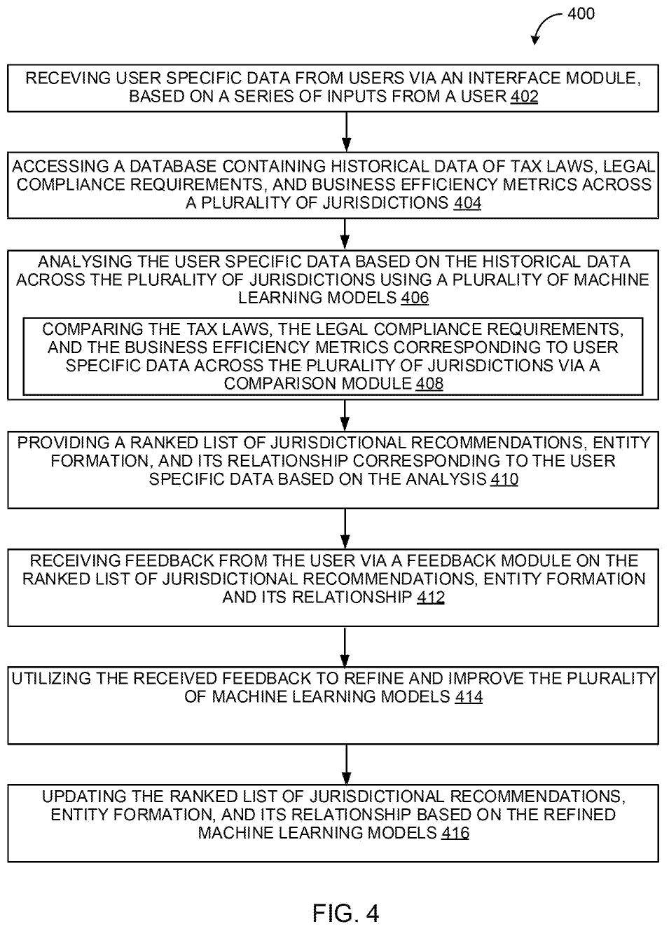

Turning now to FIG. 4, a routine 400 for strategic financial planning across jurisdictions is disclosed in accordance with an illustrative embodiment. In an embodiment, FIG. 4 is explained in conjunction with FIG. 1-3. The routine may include a plurality of steps.

At step 402, user specific data may be received via an interface module based on a series of inputs from a user. The interface module may include a dynamic questionnaire adapted to responses of the user. The dynamic questionnaire may collect the user specific data through the series of inputs. The series of inputs corresponds to tax planning needs, financial needs, business needs, and estate planning needs of the user. The user specific data may include tax planning data, financial data, business data, and estate planning data.

Further at step 404, a database containing historical data of tax laws, legal compliance requirements, and business efficiency metrics across a plurality of jurisdictions may be accessed.

Further at step 406, the user specific data may be analysed based on the historical data across the plurality of jurisdictions using a plurality of machine learning models. The plurality of machine learning models may be trained based on the historical data to analyse the user specific data. The user specific data may be analysed based on, at step 408, comparing the tax laws, the legal compliance requirements, and the business efficiency metrics corresponding to the user specific data across the plurality of jurisdictions via a comparison module. The plurality of machine learning models may include neural networks, decision trees, specifically optimized for analysing the user specific data.

Further at step 410, a ranked list of jurisdictional recommendations, entity formation, and its relationship corresponding to the user specific data may be provided based on the analysis.

Further at step 412, feedback may be received from the user via a feedback module on the ranked list of jurisdictional recommendations, entity formation, and its relationship.

Further at step 414, the received feedback may be utilized to refine and improve the plurality of machine learning models.

Further at step 416, the ranked list of jurisdictional recommendations, entity formation, and its relationship may be updated based on the refined machine learning models.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits, and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer system for strategic financial planning across jurisdictions, comprising:
an interface module configured to collect user specific data based on a series of inputs from a user, the series of inputs corresponds to tax planning needs, financial needs, business needs, and estate planning needs of the user, wherein the user specific data comprises tax planning data, financial data, business data, and estate planning data;
a database containing historical data of tax laws, legal compliance requirements, and business efficiency metrics across a plurality of jurisdictions; and
a processor configured to:
analyse the user specific data based on the historical data across the plurality of jurisdictions using a plurality of machine learning models,
wherein the plurality of machine learning models is trained based on the historical data to analyse the user specific data; and
provide a ranked list of jurisdictional recommendations, entity formation and its relationship corresponding to the user specific data based on the analysis.

2. The computer system of claim 1, wherein the interface module comprises a dynamic questionnaire adapted to responses of the user.

3. The computer system of claim 2, wherein the dynamic questionnaire collects the user specific data through the series of inputs.

4. The computer system of claim 1, wherein the plurality of machine learning models comprises neural networks, decision trees, specifically optimized for analysing the user specific data.

5. The computer system of claim 1, wherein the database is regularly updated based on scanning and incorporating changes in the tax laws, the legal compliance requirements, and the business efficiency metrics from recognized open sources.

6. The computer system of claim 1, further comprises a feedback module allowing the user to provide feedback on the ranked list of jurisdictional recommendations, entity formation and its relationship to refine and improve the plurality of machine learning models.

7. The computer system of claim 1, further comprising a comparison module to enable users to compare the tax laws, the legal compliance requirements, and the business efficiency metrics corresponding to the user specific data across the plurality of jurisdictions.

8. A computer-implemented method for strategic financial planning across jurisdiction, the computer-implemented method comprising:
receiving, by a processor, user specific data via an interface module, based on a series of inputs from a user, the series of inputs corresponds to tax planning needs, financial needs, business needs, and estate planning needs of the user, wherein the user specific data comprises tax planning data, financial data, business data, and estate planning data;
accessing, by the processor, a database containing historical data of tax laws, legal compliance requirements, and business efficiency metrics across a plurality of jurisdictions;
analysing, by the processor, the user specific data based on the historical data across the plurality of jurisdictions using a plurality of machine learning models,
wherein the plurality of machine learning models is trained based on the historical data to analyse the user specific data; and
providing, by the processor, a ranked list of jurisdictional recommendations, entity formation, and its relationship corresponding to the user specific data based on the analysis.

9. The computer-implemented method of claim 8, wherein the interface module comprises a dynamic questionnaire adapted to responses of the user.

10. The computer-implemented method of claim 9, wherein the dynamic questionnaire collects the user specific data through the series of inputs.

11. The computer-implemented method of claim 8, wherein the plurality of machine learning models comprises neural networks, decision trees, specifically optimized for analysing the user specific data.

12. The computer-implemented method of claim 8, wherein the database is regularly updated based on scanning and incorporating changes in the tax laws, the legal compliance requirements, and the business efficiency metrics from recognized open sources.

13. The computer-implemented method of claim 8, further comprising:
receiving feedback from the user via a feedback module on the ranked list of jurisdictional recommendations, entity formation and its relationship;
utilizing the received feedback to refine and improve the plurality of machine learning models; and
updating the ranked list of jurisdictional recommendations, entity formation and its relationship based on the refined machine learning models.

14. The computer-implemented method of claim 8, further comprising comparing the tax laws, the legal compliance requirements, and the business efficiency metrics corresponding to the user specific data across the plurality of jurisdictions via a comparison module.

15. A non-transitory computer-readable storage medium storing computer-executable instructions which when executed by a computer system cause the computer system to:
receive user specific data based on a series of inputs from a user, the series of inputs corresponds to tax planning needs, financial needs, business needs, and estate planning needs of the user, wherein the user specific data comprises tax planning data, financial data, business data, and estate planning data;
access a database containing historical data of tax laws, legal compliance requirements, and business efficiency metrics across a plurality of jurisdictions;
analyse the user specific data based on the historical data across the plurality of jurisdictions using a plurality of machine learning models,
wherein the plurality of machine learning models is trained based on the historical data to analyse the user specific data; and
provide a ranked list of jurisdictional recommendations, entity formation, and its relationship corresponding to the user specific data based on the analysis.

16. The non-transitory computer-readable storage medium method of claim 15, wherein the interface module comprises a dynamic questionnaire adapted to responses of the user.

17. The non-transitory computer-readable storage medium of claim 16, wherein the dynamic questionnaire collects the user specific data through the series of inputs.

18. The non-transitory computer-readable storage medium of claim 15, wherein the plurality of machine learning models comprises neural networks, decision trees, specifically optimized for analysing the user specific data.

19. The non-transitory computer-readable storage medium of claim 15, further the database is regularly updated based on scanning and incorporating changes in the tax laws, the legal compliance requirements, and the business efficiency metrics from recognized open sources.

20. The non-transitory computer-readable storage medium of claim 15, wherein the computer-executable instructions further cause the computer system to:
receive feedback from the user via a feedback module on the ranked list of jurisdictional recommendations, entity formation and its relationship;
utilize the received feedback to refine and improve the plurality of machine learning models; and
update the ranked list of jurisdictional recommendations, entity formation and its relationship based on the refined machine learning models.
